(19) United States
(12) Patent Application Publication
(10) Pub. No.: US 2024/0394597 A1
(43) Pub. Date: Nov. 28, 2024

(54) Decentralized Group Privacy in Cross-Silo Federated Learning

(71) Applicant: Oracle International Corporation, Redwood City, CA (US)

(72) Inventors: Virendra J. Marathe, Nashua, NH (US); Pallika Haridas Kanani, Westford, MA (US)

(21) Appl. No.: 18/597,771

(22) Filed: Mar. 6, 2024

Related U.S. Application Data
(60) Provisional application No. 63/502,629, filed on May 16, 2023.

(51) Int. Cl. G06N 20/00

(52) U.S. Cl. CPC G06N 20/00

(57) ABSTRACT

Federated training of a machine learning model with enforcement of subject level privacy is implemented. Respective samples of data items from a training data set are generated at multiple nodes of a federated machine learning system. Noise values are determined for individual ones of the sampled data items according to respective counts of data items of particular subjects and the cumulative counts of the items of the subjects. Respective gradients for the data items are the determined The gradients are then clipped and noise values are applied. Each subject's noisy clipped gradients in the sample are then aggregated. The aggregasted gradients for the entire sample are then used for determining machine learning model updates.

### RELATED APPLICATIONS

This application claims benefit of priority to U.S. Provisional Application Ser. No. 65/502,629, entitled “Decentralized Group Privacy in Cross-Silo Federated Learning,” filed May 16, 2023, and which is incorporated herein by reference in its entirety.

### BACKGROUND

### Field of the Disclosure

This disclosure relates generally to computer hardware and software, and more particularly to systems and methods for implementing federated machine learning systems.

### Description of the Related Art

Federated Learning (FL) has increasingly become a preferred method for distributed collaborative machine learning (ML). In FL, multiple users collaboratively train a single global ML model using respective private data sets. These users, however, do not share data with other users. A typical implementation of FL may contain a federation server and multiple federation users, where the federation server hosts a global ML model and is responsible for distributing the model to the users and for aggregating model updates from the users.

The respective federation users train the received model using private data. While the isolation of this private data is a first step toward ensuring data privacy, ML models are known to learn the training data itself and to leak that training data at inference time.

There exist methods based on Differential Privacy (DP) that ensure that individual data items are not learned by the FL trained model, however the private data of multiple federation users may include information about a single individual. In order to protect an individual's data, the FL system must enact a DP enforcement mechanism for individuals.

### SUMMARY

Methods, techniques and systems for implementing subject-level privacy preservation within federated machine learning. An aggregation server may distribute a machine learning model to multiple users each including respective private datasets. The private datasets may individually include multiple items associated with a single subject. Individual users may train the model using the local, private dataset to generate one or more parameter updates and determine a count of the largest number of items associated with any single subject of a number of subjects in the dataset. Parameter updates generated by the individual users may be modified by applying respective noise values to individual ones of the parameter updates according to the respective counts to ensure differential privacy for the subjects of the dataset. The aggregation server may aggregate the updates into a single set of parameter updates to update the machine learning model. The methods, techniques and systems may further include iteratively performing said sending, training, determining, modifying, aggregating and updating steps.

### BRIEF DESCRIPTION OF THE DRAWINGS

FIG. 1 is a block diagram illustrating a collaborative, federated machine learning system that enables multiple users to cooperatively train a Machine Learning (ML) model without sharing private training data, in various embodiments.

FIG. 2 is a logical block diagram illustrating subject-level privacy enforcement as part of a machine learning model training system, according to some embodiments.

FIG. 3 is a high-level flowchart illustrating techniques to training of a single round of a federated machine learning model while enforcing subject-level privacy, according to some embodiments.

FIG. 4 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly,

various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112 (f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Federated Learning (FL) is a distributed collaborative machine learning paradigm that enables multiple users to cooperatively train a Machine Learning (ML) model without sharing private training data. A typical FL framework may contain a central federation server and numerous federation users connected to the server. These users collaborate with other users (silos, institutions) to jointly train a common model without sharing subject data. Examples of such settings include federations of hospitals, financial institutions, etc., where the silos can leverage the aggregate of their private data to train high utility ML models. Preserving privacy of data subjects is of paramount importance to these institutions.

The model may then be updated and broadcast back to the users. This process may then repeat for several training rounds until the model converges or a fixed number of rounds is complete. FL leverages collective training data spread across all users to deliver better model performance while preserving privacy of each user's training data by locally training the model at the user.

Regarding subject level privacy in Federated Learning (FL), where a data subject (individuals whose data resides in the datasets of federation clients) can have its data records spread across a multitude of federation clients, prior work enforces subject level privacy locally at each client and extrapolates the guarantee across the whole federation by making conservative assumptions about privacy loss composition. Instead, described herein is a global view of subject privacy enforcement. DecGDP accurately captures contributions of individual data subjects across all sampled clients in a training round, calculates the precise amount of noise needed to obfuscate the use of each subject in the training round, and randomly redistributes the calculated noise to the sampled clients. All these tasks are performed by systematically assembling a diverse set of model training and privacy enforcement techniques on top of the popular DP-SGD algorithm-federated SGD (FedSGD), cryptographic hashes, a trusted third-party noise shuffler, and decentralized noisy gradient aggregation. DecGDP enforces Group Differential Privacy (GDP), which entails subject level privacy.

We assume an honest-but-curious privacy threat model, where both the federation server and the clients perform their part in training honestly, but can perform arbitrary analysis on the data they observe (e.g. model parameter gradients and updates). We also assume that the server and clients are non-colluding.

The above setting necessitates privacy preservation of subjects even when their data is spread across multiple silos in the federation. For instance, consider the medical history records of an individual who is a patient at multiple hospitals. These hospitals themselves are participating as clients in the same federation. The individual's health data, which can appear in training data of multiple hospitals, must be protected during training.

Privacy enforcement for all subjects must be done in a decentralized fashion, at clients, such that neither the federation server, nor the clients can determine the aggregate noise introduced during training. DecGDP builds on DP-SGD, and systematically assembles a diverse set of model training and privacy enforcement techniques-federated SGD (FedSGD), cryptographic hashes, a trusted third-party noise shuffler, and decentralized gradient aggregation to effectively achieve the above goals.

DecGDP enforces the Group Differential Privacy (GDP) guarantee for data subjects across the whole federation. The relevant noise needed to enforce GDP is calculated by combining privacy amplification due to GDP with the noise calculated using the moments accountant method for item level DP. DecGDP leverages PHE and the noise shuffler to aggregate and re-distribute the noise to multiple clients to fully obfuscate every subject's contribution in each training round.

Various techniques for enforcing subject level privacy are described herein. Machine learning models are trained using training data sets. These data sets may include various data items (e.g., database records, images, documents, etc.) upon which different training techniques may be performed to generate a machine learning model that can generate an inference (sometimes referred to as a prediction). Because machine learning models “learn” from the training data sets, it may be possible to discover characteristics of the training data sets, including actual values of the training data sets, through various techniques (e.g., by submitting requests for inferences using input data similar to actual data items of a training data set to detect the presence of those actual data items). This vulnerability may deter or prevent the use of machine learning models in different scenarios. Therefore, techniques that can minimize this vulnerability may be highly desirable, increasing the adoption of machine learning models in scenarios where the use of those machine learning models can improve the performance (or increase the capabilities) of various systems, services, or applications that utilize machine learning models to perform different tasks.

Federated learning is one example where techniques to prevent loss of privacy from training data sets for machine learning models, as discussed above, can be beneficial. Federated learning is a distributed training paradigm that lets different organizations, entities parties, or other users collaborate with each other to jointly train a machine learning model. In the process, the users do not share their private training data with any other users. Federated learning may provide the benefit of the aggregate training data across all its users, which typically leads to much better performing models.

Federated learning may automatically provide some training data set privacy, as the data never leaves an individual user's control (e.g., the device or system that performs training for that user). However, as machine learning models are known to learn the training data itself, which can leak out at inference time. Differential privacy provides a compelling solution to the data leakage problem. Informally, a differentially private version of an algorithm A introduces enough randomization in A that makes it harder for an adversary to determine if any specific data item was used as an input to A. For machine learning models, differential privacy may be used to ensure that an adversary cannot reliably determine if a specific data item was a part of the training data set.

For machine learning model training, differential privacy is introduced in the model by adding carefully calibrated noise during training. In the federated learning setting, this noise may be calibrated to hide either the use of any data item, sometimes referred to as item level privacy, or the participation of any user, sometimes referred to as user level privacy, in the training process. User level privacy may be understood to be a stronger privacy guarantee than item level privacy since the former hides use of all data of each user whereas the latter may leak the user's data distribution even if it individually protects each data item.

Item level privacy or user level privacy may provide beneficial privacy protection in some scenarios (e.g., cross-device federated learning consisting of millions of hand-held cell phones, where, for instance, a user may be an individual with data that typically resides in one device, such as a mobile phone, that participates in a federation and one device typically only contains one individual's data). However, the cross-silo federated learning setting, where users are organizations that are themselves gatekeepers of data items of numerous individuals (which may be referred to as “subjects”), offer much richer mappings between subjects and their personal data.

Consider the following example. An online retail store customer C. C's online purchase history is highly sensitive, and should be kept private. C's purchase history contains a multitude of orders placed by C in the past. Furthermore, C may be a customer at other online retail stores. Thus, C's aggregate private data may be distributed across several online retail stores. These retail stores could end up collaborating with each other in a federation to train a model using their customers', including C's, private purchase histories.

Item level privacy does not suffice to protect the privacy of C's data. That is because item level privacy simply obfuscates participation of individual data items in the training process. Since a subject may have multiple data items in the data set, item level private training may still leak a subject's data distribution. User level privacy also does not protect the privacy of C's data either. User level privacy obfuscates each user's participation in training. However, a subject's data can be distributed among several users, and it can be leaked when aggregated through federated learning. In the worst case, multiple federation users may host only the data of a single subject. Thus C's data distribution can be leaked even if individual user's participation is obfuscated.

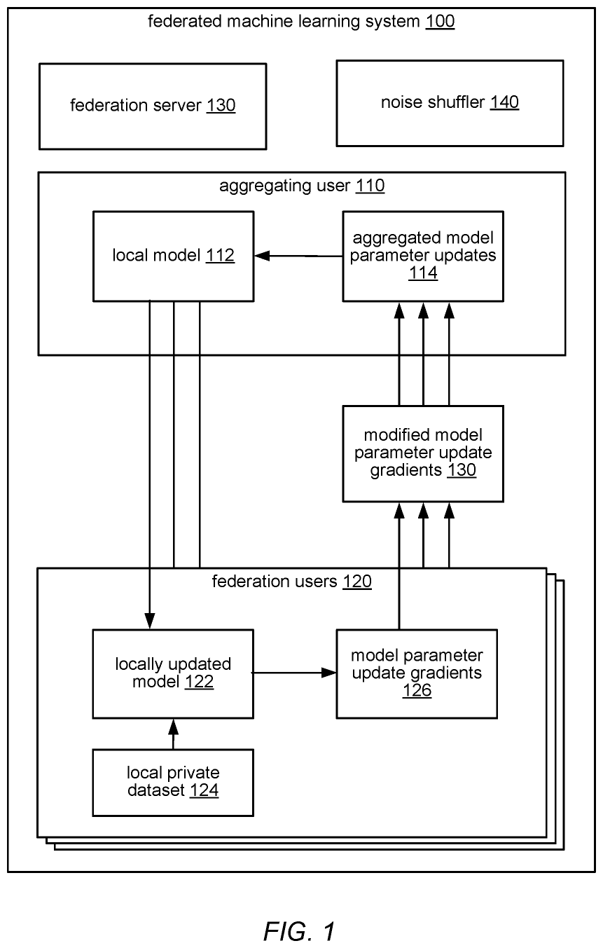

FIG. 1 is a block diagram illustrating a collaborative, federated machine learning system that enables multiple users to cooperatively train a Machine Learning (ML) model without sharing private training data, in various embodiments.

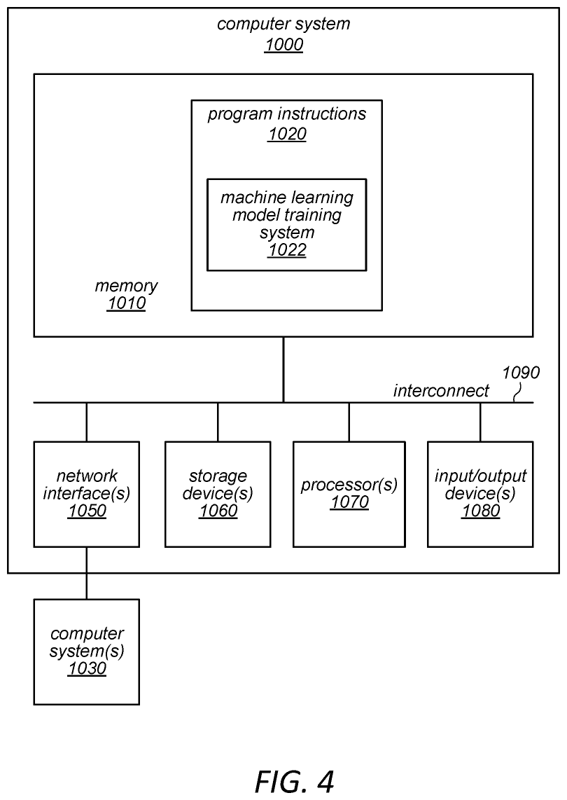

A federated machine learning system 100 may include a federation server 130, a noise shuffler 140 and multiple federation users 110 and 120. The elements 110, 120, 130 and 140 may be implemented, for example, by computer systems 1000 (or other electronic devices) as shown below in FIG. 4. During training, one of the federation users 110 may be selected to function as an aggregating user. The aggregating user 110 may maintain a local machine learning model 112 and, to perform training, may distribute a current version of the machine learning model 112 to the federation users 120.

Individual ones of the federation users 120 may independently generate locally updated versions of the machine learning model 122 by training the model using local, private datasets 124. This independently performed training may then generate model parameter update gradients 126.

Noise may be applied to respective model parameter update gradients 126 to generate modified model parameter update gradients 130. This noise may be applied in accordance with respective counts of data items of particular subjects in training batches of the respective users in proportion to total counts of the data items for all federation users. Once the modified model parameter update gradients 130 have been generated, the modified model parameter update gradients 130 may then be sent to the central aggregating user 110.

Upon receipt of the collective modified model parameter update gradients 130, the central aggregation server 110 may then aggregate the respective modified model parameter update gradients 130 to generate aggregated model parameter updates 114. The central aggregation server 110 may then apply the aggregated model parameter updates 114 to the current version of the model 112 to generate a new version of the model 112. This process may be repeated a number of times until the model 112 converges or until a predetermined threshold number of iterations is met.

In various embodiments, differential privacy may bound the maximum impact a single data item can have on the output of a randomized algorithm, [symbol] . Thus, differential privacy may be described where randomized algorithm [symbol] : [symbol] → [symbol] is said to be (ε, δ) differentially private if for any two adjacent data sets D,D′∈ [symbol] , and set R⊆ [symbol] , [symbol] ( [symbol] ( [symbol] )∈R)≤e^{ϵ}( [symbol] ( [symbol] (D′)∈R)+δ (equation 1) where D,D′ are adjacent to each other if they differ from each other by a single data item. δ is the probability of failure to enforce the ε privacy loss bound. The above description may provide item level privacy.

Differential privacy may be described differently in other scenarios, such as federated learning. Let [symbol] be the set of n users participating in a federation, and [symbol] ᵢ be the data set of user uᵢ∈ [symbol] . Let [symbol] =Uᵢ₌₁ⁿ [symbol] ᵢ. Let [symbol] be the domain of models resulting from the federated learning training process. Given a federated learning training a [symbol] : [symbol] → [symbol] , [symbol] is a user level (ε, δ) differentially private if for any two adjacent user sets U,U′⊆ [symbol] , and set R⊆ [symbol] , [symbol] ( [symbol] ( [symbol] _{U})∈R)≤e^{ϵ}( [symbol] ( [symbol] ( [symbol] _{U′})∈R)+δ (equation 2) where U,U′ are adjacent user sets differing by a single user.

Let S be the set of subjects whose data is hosted by the federation's users U. A description of subject level differential privacy may be, in some embodiments, based on the observation that even though the data of individual subjects s∈S may be physically scattered across multiple users in [symbol] , the aggregate data across [symbol] can be logically divided in to its subjects in S (e.g., [symbol] =U_{s-S} [symbol] ₛ). Given a federated learning training algorithm [symbol] : [symbol] → [symbol] , where [symbol] is a subject level (ε, δ) differentially private if for any two adjacent subject sets S,S′⊆ [symbol] and R⊆ [symbol] , [symbol] ( [symbol] ( [symbol] _{S})∈R)≤e^{ϵ}( [symbol] ( [symbol] ( [symbol] _{S′})∈R)+ϵ (equation 3) where S and S′ are adjacent subject sets if they differ from each other by a single subject. This description may ignore the notion of users in a federation. This user obliviousness allows for subject level privacy to be enforced in different scenarios, such as a single data set scenario (e.g., either training a model with multiple subjects but not in a federated learning scenario or in a federated learning scenario in which a subject's data items are located in a single user (e.g., a single device)) or a federated learning scenario where a subject's data items are spread across multiple users (e.g., a for a cross-silo federated learning setting).

The subject level DP definition does not put any restrictions on subject cardinality in a dataset and captures the informal descriptions of protecting privacy of individuals. An interesting side effect of the definition of DP covers privacy of arbitrary groups of data items in a dataset. This is referred to as Group Differential Privacy (GDP).

Given a dataset domain [symbol] and output range [symbol] , any (ε, δ)-differentially private mechanism [symbol] : [symbol] → [symbol] is (gε,gε^{(g-1)ε}δ)-group differentially private for groups of size g. That is, for all D,D′∈ [symbol] such that ∥D−D′∥₁≤g, and S⊆R, [symbol] r[M(D)∈S≤e^{gϵ}( [symbol] r(M(D′)∈S)+gε^{(g-1)ε}δ. GDP implies subject level privacy: an (ε, δ)-DP guarantee for a group size g provides the same guarantee for the privacy of subject s∈Q with cardinality |D_{S}|=g in the dataset D_{Q}.

Each step t, which updates parameters θₜ₋₁ from the previous step, may be compactly represented by:

$${Θ}_{t} = {Θ}_{t - 1} + \frac{η}{b} ( {\sum }_{i = 1}^{b} Clip ( ∇ {L}_{i} , C ) + N ( 0 , {C}^{2} {σ}^{2} ) ) \qquad ( equation 4 )$$

where η is the learning rate, b is the mini-batch size, ∇Lᵢ is the gradient of data item i in the mini-batch, Clip( ) norm bounds the gradient to threshold C, and σ is the noise scale derived using a moment accountant method.

There exist constants k₁ and k₂ such that given the sampling probability

$$\\ q = \frac{B}{\vert D \vert} ,$$

where B is the mini-batch size, D is the training dataset, and T is the number of steps, for any ϵ<k₁q²T, DP-SGD is (ε, δ)-differentially private for any δ>0 if we choose:

$$σ \geq {k}_{2} \frac{q \sqrt{T log ( \frac{1}{δ} )}}{ε} \qquad ( equation 5 )$$

To achieve subject level privacy, we would like to enforce GDP across the whole federation. Our solution to achieve GDP requires a global view of a subject's participation in training the model collaboratively. To that end, we want to first globally identify the exact impact the subject's data items have at each federation client. At the same time, we want to avoid leaking any information about individual subjects from individual clients. Next, the privately identified influence of a subject must be accurately aggregated to determine the overall impact of the subject on the aggregate model. This aggregate effect of the subjects cannot be sent to the clients since it could leak to them additional information on individual subjects (e.g. how densely populated is a specific subject's data among other federation clients). Thereafter, the aggregate noise needed to achieve GDP needs to be computed and divided among the clients in such a way that the clients cannot determine the aggregate noise. Lastly, the noisy parameter updates must be aggregated in a decentralized fashion to make sure that the server cannot determine the exact update of each client.

DecGDP uses the Federated Stochastic Gradient Descent (FedSGD) algorithm for model training. In FedSGD, a client simply computes gradients for a single sampled mini-batch and returns them to the federation server. The server in turn averages the received gradients and applies them to the server-resident copy of the model, which is then broadcasted to clients sampled in the next training round. The choice of FedSGD simplifies the task of putting together a global view of subject contributions to model updates in each training round.

We assume that the data records in training datasets of each client contain a subject identifier (Id) that uniquely identifies the data subject. Furthermore, we assume that clients consistently agree on subject Ids for the same subjects; so clients A and B would have the same Id for say subject s. The clients share one-way cryptographic hashes (SHA512) of their mini-batch's subject Ids with the noise shuffler (discussed below). Agreement in subject Ids is a critical first step in capturing the global contribution of each subject in each training round of the federation.

At the foundation of our approach is a flexible mathematical formulation of the Gaussian noise needed to guarantee GDP in DP-SGD, given group size g. Our GDP noise formulation is derived from the Gaussian noise in Equation 5 needed to guarantee (ε, δ)-DP in DP-SGD. Let A: [symbol] → [symbol] denote an instance of DP-SGD that is trained for T mini-batches with mini-batch sampling probability of q. Then if algorithm A is (ε, δ)-group differentially private for group size g, then the Gaussian noise scale σ_{g} needed to guarantee the privacy is lower bounded by:

$${σ}_{g} \geq σ \frac{g}{\sqrt{log ( \frac{1}{δ} )}} \sqrt{log \frac{g}{δ} + \frac{( g - 1 ) ε}{2 q \sqrt{T}}} \qquad ( equation 6 )$$

Where σ is the noise scale computed using equation 5 for group size g at client cᵢ.

From Equation 4 and Equation 6, the Gaussian noise needed to guarantee GDP for group size g is [symbol] (0, C²σ_{g}²). In other words, the noise hides the gradients of all g data items from the group. Additionally, the gradients of each data item are restricted to the sensitivity of C by gradient clipping, to which we tune the noise. Thus, by composition of Gaussian random variables, the effective noise needed to obfuscate the gradients of any single data item in a group of g data items is the random variable from the distribution

$$\\ 𝒩 ( 0 , {C}^{{}_{} 2} \frac{{σ}_{g}^{{}_{} 2}}{g} ) .$$

Ignoring the constant C², for clients c₁, c₂, . . . , cₙ, the variance of Gaussian noise for group size g is σ_{c}_{₁}_{,g}², σ_{c}_{₂}_{,g}², . . . , σ_{c}_{ₙ}_{,g}² respectively. These are necessary to guarantee GDP for group size g at any of the clients. By the above analysis, the variance of the Gaussian noise attributable to each data item of any group of size g is

$$\\ \frac{{σ}_{{c}_{1} , g}^{{}_{} 2}}{g} , \frac{{σ}_{{c}_{2} , g}^{{}_{} 2}}{g} , … , \frac{{σ}_{{c}_{n} , g}^{{}_{} 2}}{g}$$

respectively.

The following pseudo code provides an example implementation of a noise shuffling process in DecGDP. In the following pseudo code, parameters may be described as follows:
Set of n users C=cᵢ, cu₂, . . . , cₙ
σ_{c}_{₁}², noise scales at client cᵢ for group values g∈[G]
σ_{c}_{ᵢ}_{,g}², noise scale at client cᵢ for group size g
σ_{C}, collection of noise scales for all clients
S_{C}_{ᵢ}, subject Ids to item count map in mini-batch of client

$$\\ S = {⋃}_{{c}_{i} ∈ C} {}_{} {S}_{{C}_{i}}$$

### ShuffleNoise (σ_{C}, S):

```
for s ∈ S do
  // Compute aggregate subject counts for all subjects.
  gₛ = Σᵢ₌₁ⁿ S_{c}_{ᵢ}(s)
  Aggs.Put(s, gₛ)
    // Compute σₛ² per subject s
  ${σ}_{s}^{2} = {\sum }_{i = 1}^{n} \frac{{s}_{{c}_{i}} ( s )}{{g}_{s}} {σ}_{{c}_{i} , {g}_{s}}^{2} [ s ]$
σₘₐₓ = max(Agg_{σ})
σ_{c}_{₁}, σ_{c}_{₂}, . . . , σ_{c}_{ₙ} = random_split(σₘₐₓ)
return σ_{c}_{₁}, σ_{c}_{₂}, . . . , σ_{c}_{ₙ}
```

However, when the data items of a group of size g are spread across these clients, each client cᵢ contains gᵢ≤g data items from the group such that g=Σᵢ₌₁ⁿgᵢ. Thus client cᵢ contributes

$$\frac{{g}_{i}}{g}$$

fraction of data items in the group. Correspondingly, the variance of Gaussian noise per data item of a

$$\frac{{σ}_{{c}_{i} , g}^{2}}{g}$$

must be scaled by gᵢ at each client cᵢ to match with gᵢ data items in the group. Aggregating these scaled variances across all n clients, we get a new cumulative variance of

$$\\ {σ}_{g}^{{}_{} 2} = {\sum }_{i = 1}^{n} \frac{{g}_{i}}{g} {σ}_{{c}_{i} , {g}_{s}}^{{}_{} 2} .$$

Thus the noise scale is a weighted sum of noise scales of the clients that contain data items belonging to a given group of data items. To extend this GDP guarantee to subject level DP, it is easy to see that a GDP guarantee for group size g entails subject level DP guarantee for subjects with g or fewer data items in a sampled mini-batch.

Each round of FedSGD comprises gradient computation of an “aggregate mini-batch”, which is the average of mini-batch gradients of all the clients sampled in that round. We want to perform the operation in Equation 7 for each subject s sampled in this aggregate mini-batch. To that end, we must determine the aggregate group size g for each s in the aggregate mini-batch and then compute the weighted sum of variance for each subject. Injecting Gaussian noise using the largest weighted sum is sufficient to obfuscate each subject s from the aggregate mini-batch.

Critically, we want this noise aggregation to be completely opaque to the federation server and all the clients. Furthermore, the clients must observe only the end product of the aggregation in a way that hides the aggregate noise from them. The federation server should not even observe any output from noise aggregation.

To achieve the above goals DecGDP uses a trusted third-party noise shuffler [symbol] . [symbol] does not communicate with the federation server at all. However, in each training round t, [symbol] communicates with the clients sampled by the server in round t. Algorithm 1 shows the pseudo code for the client- [symbol] interaction.

[symbol] receives two pieces of information from each sampled client cᵢ—the subjects sampled in cᵢ's mini-batch, and the noise scale σ_{c}_{ᵢ}_{,g}². Clients do not send subject Ids to [symbol] , instead they send one-way cryptographic hashes (SHA-512) of subject Ids sampled in the mini-batch. In more detail, cᵢ sends a map of subject Id hashes to counts that indicate the number of data items of a given subject that appear in the mini-batch. After receiving these subject count maps, [symbol] can easily compute the aggregate sum of each subject s's participation count g, over all sampled clients. Recall our assumption that clients agree on subject Ids for the same subjects, e.g. phone numbers, social security numbers, etc. Since they use the same cryptographic hashing protocol, the subject Id hashes for the same subject by any two clients match. This gives us a global view of the participation of each subject s in the aggregate mini-batch.

The following pseudo code provides an example implementation of a decentralized gradient aggregation protocol in DecGDP. This protocol is invoked by the federation server at a randomly chosen client sampled in the training round. In the following pseudo code, parameters may be described as follows:

```
  Set of m order clients C = cᵢ, cᵤ₂, ... , cₙ
  σₛₜₐᵣₜ, startup noise added by c₁ to hide gradients from c₂
  own_grads, gradients computed at each client
  agg_grads, aggregate gradients initialized to 0
  σ_{c}_{ᵢ}, precomputed noise scale for client cᵢ
DecGradAgg(C, agg_grads) :
  / / c₁ = own
  agg_grads = agg_grads + σₛₜₐᵣₜ
  agg_grads = agg_grads + own_grads + [symbol]    (0,σ_{c}_{₁})
  fut = c₂ DecGradFwd(C,agg_grads)
  Wait(fut)
  own_grads = own_grads − σₛₜₐᵣₜ
  return own_grads
Degreef'd(C, agg_grads) :
  / / c₁ = own
  agg_grads = agg_grads + own_grads + [symbol]    (0,σ_{c}_{ᵢ})
  if c₁ = cₘ:own_grads = agg_grads
  else: cᵢ₊₁.DecGradFwd(C,agg_grads)
```

Clients also send a collection of their local noise scales for group sizes up to a specified threshold G, i.e. g∈[G]. Thus [symbol] receives a list of σ_{c}_{ᵢ}_{,g} ƒ or g∈1, 2, . . . , G from each sampled client cᵢ. For each client cᵢ, using its noise scale lists, individual subject count gₛ, [symbol] can calculate the aggregate noise for each subject s as

$$\\ {σ}_{s}^{{}_{} 2} = {\sum }_{i = 1}^{n} \frac{{g}_{{s}_{i}}}{{g}_{s}} {σ}_{{c}_{i} , {g}_{s}}^{{}_{} 2} .$$

[symbol]

then selects the largest noise scale σ_{L}² which covers privacy for all subjects sampled in the aggregate mini-batch.

While DecGDP borrows the “one mini-batch per training round” strategy from FedSGD, it takes a different approach to noisy gradient aggregation in that the aggregation is done directly by the clients in a completely decentralized manner. This way the server cannot determine the exact gradients coming from any single client (the non-collusion assumption in our privacy threat model is critical for this strategy to work).

The pseudo code for our decentralized gradient aggregation algorithm appears in Algorithm 2. The federation server triggers the algorithm by invoking DecGradAgg at the first client in the ordered client set C. Client c₁ is essentially the “head node” of a chain of nodes that aggregate the gradients in a decentralized fashion. The head client provisionally injects an arbitrarily large amount of noise in agg_grads to completely obfuscate its noisy gradients. This step is primarily taken to obfuscate c₁'s gradient updates from c₂ in case the randomly assigned noise σ_{c}_{₁} to c₁ by [symbol] is arbitrarily small. In fact σₛₜₐᵣₜ provides this protection to all clients c₁, c₂, . . . , cₙ in cases where most of the noise is randomly assigned by [symbol] to cₙ. σₛₜₐᵣₜ is subsequently cancelled out by c₁. The rest of the clients add their noisy gradients to the accumulated agg_grads and forward the updated agg_grads to the next client in the chain.

The decentralized accumulation of the noise eventually adds up to the total noise prescribed by [symbol] for the aggregate mini-batch:

$$\\ \begin{matrix}𝒩 ( 0 , {σ}_{L}^{{}_{} 2} ) = {\sum }_{i = 1}^{n} 𝒩 ( 0 , {σ}_{{L}_{i}}^{{}_{} 2} ) . & ( equation 7 )\end{matrix}$$

The following pseudo code provides an example implementation of DecGDP. In the following pseudo code, parameters may be described as follows:

```
      T, number of training rounds
      C = cᵢ, cu₂, . . . , cₙ, the set of federation clients
      η, learning rate
      σ_{c} , collection of all n σ_{c}_{ᵢ}_{,g}² lists, one for each client cᵢ
      σ_{c}_{ᵢ}= ∪_{g∈[G]} σ_{c}_{ᵢ}_{,g}
      S_{c}_{ᵢ}, the subject to item count map at a client cᵢ [symbol]
      , loss function
ServerLoop:
  Initialize Θ₀
  for t = 1 to T do
    Cₙ =sample n clients from C [symbol]
    .PrepareMiniBatches(Cₙ)
    for cᵢ ∈ Cₙ do
      cᵢ.ComputeGrad(Θₜ₋₁)
    Δ₀= 0
    Δ = c₁.DecAggGrad(Cₙ, Δ₀)
    ${Θ}_{t} = {Θ}_{t - 1} - \frac{η}{n} Δ$
  return Θ_{T}
ComputeGrad(Θₜ₋₁):
  // Db is pre-sampled mini-batch of size b at cᵢ
  for d ∈ D_{b} do
    // Compute gradients
    g̅_̅{̅d̅}̅ = Clip(gd, C)
  $\overline{g} = \frac{1}{b} {\sum }_{d ∈ {D}_{b}} \overline{{g}_{d}} + 𝒩 ( 0 , {σ}_{{L}_{i}}^{2} )$
  return
```

In each training round, the federation server first requests the noise shuffler [symbol] to prepare mini-batches at all n sampled clients cᵢ and set them up with the noise scale σ_{L}_{ᵢ}, (same as σ_{c}_{ᵢ}) for their respective mini-batch gradients. The noisy mini-batch gradients are then compute at each cᵢ, followed by their aggregation in a decentralized fashion (starting at line 9). Finally the aggregated gradients are applied to the model parameters, and a new round commences thereafter.

Privacy Analysis From a privacy analysis perspective, it is straightforward to see that DecGDP mathematically performs the same noisy gradient aggregation that differentially private FedSGD would perform, based on Equation 4 and Equation 7. Furthermore, at each training round, the group size g is the cardinality of the largest group of data items belonging to any subject sampled in the aggregate mini-batch.

At each training round t, the Gaussian noise scale σ_{|s}_{_{L}}_{|} for the aggregate mini-batch satisfies:

$$\\ \begin{matrix}{σ}_{\vert {s}_{L} \vert}^{{}_{} 2} = {\sum }_{i = 1}^{n} \frac{\vert {s}_{{L}_{i}} \vert}{\vert {s}_{L} \vert} {σ}_{{c}_{i} , \vert {s}_{L} \vert}^{{}_{} 2} & ( equation 8 )\end{matrix}$$

Where s_{L} is the subject with the largest sampled group size |s_{L}| in t's aggregate mini-batch, and s_{L}_{ᵢ} is the number of data items of s_{L} contributed by client cᵢ in its respective local mini-batch.

Let DecGDP train for T rounds, and in each training round t let gₛ=|s_{L}|, where s_{L} is the most frequent subject's set of data items appearing in the aggregate mini-batch, and gₛ_{ᵢ}=|s_{L}_{ᵢ}| where s_{L}_{ᵢ} is the set of data items of that subject sampled in client cᵢ's local mini-batch.

DecGDP is subject level (ε, δ) differentially private if the Gaussian noise Scale σₜ for the aggregate mini-batch in each training round t satisfies:

$$\\ \begin{matrix}{σ}_{t}^{{}_{} 2} \geq {\sum }_{i = 1}^{n} \frac{{g}_{{s}_{i}}}{{g}_{s}} {σ}_{{c}_{i}}^{{}_{} 2} \frac{{g}_{{s}_{i}}^{{}_{} 2}}{log ( \frac{1}{δ} )} ( log \frac{{g}_{{s}_{i}}}{δ} + \frac{( {g}_{{s}_{i}} - 1 ) ε}{2 {}_{} {q}_{{c}_{i}} \sqrt{T}} ) & ( equation 9 )\end{matrix}$$

Where q_{c}_{ᵢ} is the sampling fraction at client cᵢ, and σ_{c}_{ᵢ} is the noise scale needed to guarantee (ε, δ) differential privacy at client cᵢ.

Let Z denote the data domain and D denote a data distribution over Z. Assume a L-Lipschitz convex loss function l: [symbol] ^{d}×Z→ [symbol] that maps a parameter vector w∈W, where W⊂ [symbol] ^{d} is a convex parameter space, and a data point z∈Z, to a real value.

Given the parameter vector w∈W, dataset D=d₁, d₂, . . . , dₙ, where dᵢ∈Z, and loss function l, we define the empirical loss of w as

$$\hat{ℒ} ( w ; D ) {=}^{Δ} \frac{1}{n} {\sum }_{i = 1}^{n} l ( w , {d}_{i} ) ,$$

and the excess empirical loss of w as Δ [symbol] (w;D)≙ [symbol] (w;D)−min_{\tilde{w}∈W} [symbol] (w;D). Similarly we define the population loss of w∈W with respect to loss l and a distribution D over Z as [symbol] (w;D)≙ [symbol] (w;D)−min_{\tilde{w}∈W} [symbol] (\tilde{w};D).

Let A_{SDP} be a L-Lipschitz randomized algorithm that guarantees subject level (ε, δ) DP. For any η>0, the excess population loss of A_{SDP} is bounded by:

$$\\ Δ ℒ ( {A}_{SDP} ; D ) \leq {𝔼}_{D \sim {D}^{{}_{} n} , {A}_{SDP}} [ ℒ ( {\hat{w}}_{T} ; D ) - {min}_{{}_{} w ∈ W} ℒ ( w ; D ) ] + {L}^{2} \frac{η ( T + 1 )}{n}$$

The above loss bound is more general than just subject level DP, and applies to GDP as well.

Let W be the M-bounded convex parameter space for DecGDP, and D∈Zⁿ be the input (training) dataset. Let (ε, δ) be the subject level DP parameters for DecGDP, q_{c}_{ᵢ} be the mini-batch sampling ratio for client cᵢ, d the model dimensionality, and C be the number of clients sampled in each round. The excess empirical loss of DecGDP satisfies:

$$\\ 𝔼 [ ℒ ( {\overline{w}}_{T} ; D ) ] - {min}_{{}_{} w ∈ W} ℒ ( w ; D ) ] \leq \frac{{M}^{{}_{} 2}}{2 η T} + \frac{η {L}^{2}}{2} + η {dk}_{2}^{{}_{} 2} \frac{gT}{{ℰ}^{{}_{} 2}} {\sum }_{i = 1}^{C} {g}_{i} {q}_{{c}_{i}}^{{}_{} 2} ( log \frac{g}{δ} + \frac{( g - 1 ) ε}{2 {qc}_{i} \sqrt{T}} )$$

The following description provides for various features of implementing privacy techniques in federated learning scenarios. The federated learning server may be responsible for initialization and distribution of the model architecture to the federation users, coordination of training rounds, aggregation and application of model updates coming different users in each training round, and redistribution of the updated model back to the users. Federated users may receive updated models, retrain the received models using private training data, and return updated model parameters to an aggregator.

It may be assumed in some federated learning scenarios that the federation users and the federation server behave as honest-but-curious participants in the federation: they do not interfere with or manipulate the distributed training process in any way, but may be interested in analyzing received model updates. Federation users do not trust each other or the federation server, and may locally enforce privacy guarantees for their private data.

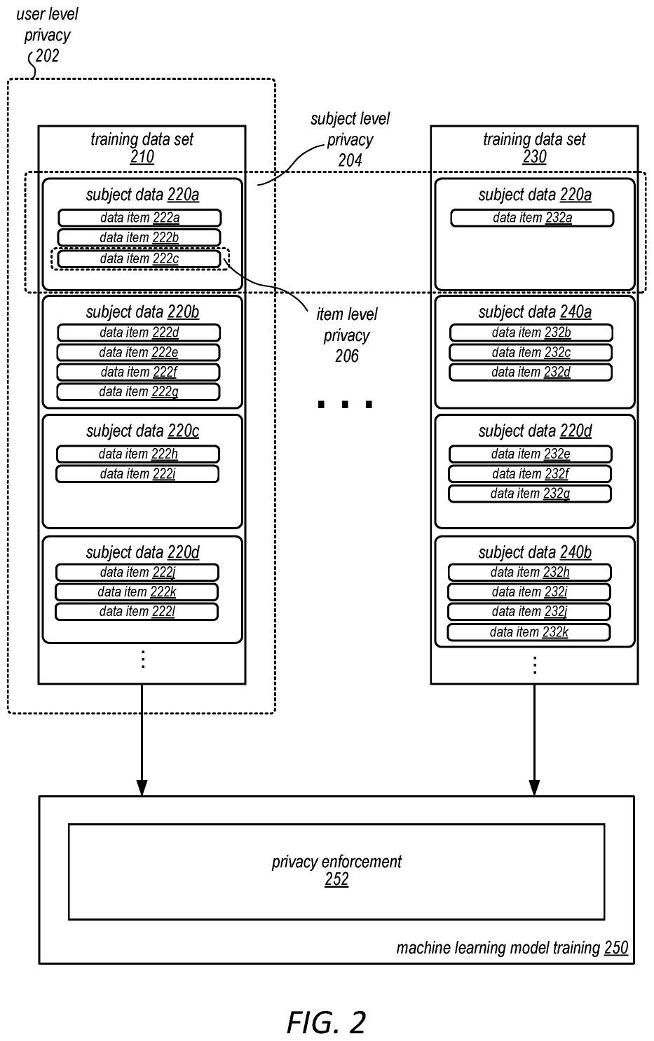

FIG. 2 is a logical block diagram illustrating subject level privacy enforcement as part of a machine learning model training system, according to some embodiments. Training data set 210 may illustrate the various privacy levels which can be protected, in some embodiments. For example, within training data set 210 are various data items 222a, 222b, 222c, 222d, 222e, 222f, 222g, 222h, 222i, 222j, 222k, and 222l. Each of these data items may be associated with a subject. Thus, as illustrated in FIG. 2, subject data 220a includes data items 222a, 222b, and 222c, subject data 220b includes data items 222d, 222e, 222f, and 222g, subject data 220c includes data items 222h and 222i, and subject data 220d includes data items 222j, 222k, and 222l. Different privacy types are indicated in FIG. 2. User level privacy 202 is enforced for training data set 210, subject level privacy 204 is enforced respectively for each subject's data (e.g., subject data 220a), and item level privacy 206 is enforced respectively for individual data items (e.g., data item 222c).

As noted above, a subject's data can be spread across multiple training data sets, like training data set 230. For example, training data set 230 may include data items 232a, 232b, 232c, 232d, 232e, 232f, 232g, 232h, 232i, 232j, and 232k. These data items may be associated with different subjects. Thus, as illustrated in FIG. 2, subject data 220a includes data item 232a, subject data 240a includes data items 232b, 232c, and 232d, subject data 220d includes data items 232e, 232f and 232g, and subject data 240b includes data items 232h, 232i, 232j, and 232k.

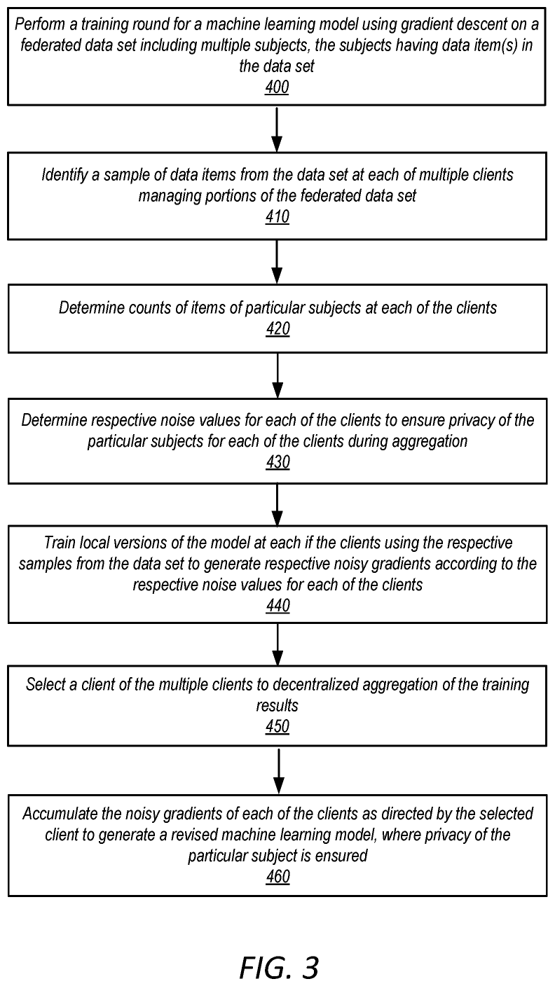

One (or both) of training data sets 210 and 230 may be used as part of machine learning model training 250 (e.g., as part of various systems discussed below with regard to FIGS. 3 and 4). To protect a subject's data privacy, various techniques for enforcing subject level privacy may be implemented, in various embodiments. Subject level privacy may be enforced for scenarios where a subject is an individual (or other sub-entity) whose private data can be spread across multiple data items across one or more training data sets (e.g., at a machine learning model trained for one user or across multiple different users in a federated machine learning scenario).

Federated learning allows multiple parties to collaboratively train a machine learning model while keeping the training data decentralized. Federated learning was originally introduced for mobile devices, with a core motivation of protecting data privacy. In a cross-device setting (e.g., across mobile devices), privacy is usually defined at two granularities: first, item-level privacy, which describes the protection of individual data items and user-level privacy, which describes the protection of the entire data distribution of the device user.

Subject level differential privacy may be enforced using differential privacy, in various embodiments. Such techniques in federated learning embodiments may assume a conservative trust model between the federation server and its users; the users do not trust the federation server (or other users) and enforce the subject level differential privacy locally.

Various different systems, services, or applications may implement the techniques discussed above. For example, FIG. 3, discussed below, provides an example computing system that may implement various ones of the techniques discussed above. FIG. 3 is a high-level flowchart illustrating techniques to training of a single round of a federated machine learning model while enforcing subject-level privacy, according to some embodiments.

As indicated at 400, a machine learning model may be trained using gradient descent on a data set including multiple subjects, in some embodiments. The multiple subjects may have one (or more) data items in the data set. For example, as discussed above with regard to FIG. 2, a training data set may have multiple data items. Each data item may be associated with a subject (which may be indicated in the data item, such as a field or attribute of the data item), and there may be multiple subjects in a training data set. The training of the machine learning model may be performed as part of a federated learning training system, where the training is performed by a user and where the data set is a private data set that is not shared with other users in the federated learning system.

In various embodiments, different types of machine learning models may be trained including various types of neural network-based machine learning models. Various types of gradient descent training techniques may be implemented, such as batch gradient descent, stochastic gradient descent, or mini-batch gradient descent. Gradient descent training techniques may be implemented to minimize a cost function (e.g., a difference between a predicted value or inference of the machine learning model given an input from a training data set and an actual value for the input) according to a gradient and a learning rate (e.g., a “step size” or α).

As indicated at 410, a sample of data items from the data set may be identified at each of multiple federated clients managing portions of the federated data set, in some embodiments. For example, various different random sampling techniques (e.g., using random number generation) may be implemented to select the sample of data items. The sample of data items may be less than the entire number of data items from the data set, in some embodiments. In this way, different samples taken for different iterations of the technique performed in a training round (e.g., for different mini-batches) may likely have at least some data items that are different from a prior sample.

As indicated at 420, counts of items for a particular subject in the sampled data may be determined at each of the clients and a total number for all clients may be determined. Then, as shown in 430 noise may be apportioned to each of the clients according to respective count values and the total count, with the noise applied during aggregation to ensure privacy of the particular subject.

As shown in 440, local versions of models may be trained at each of the federation clients using the respective sampled data. Respective gradients for individual data items in the sample of data items may be determined, in some embodiments. For example, partial derivatives of a given function may be taken with respect to the different machine learning model parameters for a given input value of an individual data item. Respective gradients for the individual data items in the sample of data items may be clipped according to a threshold. As discussed above, a clipping threshold (e.g., C) may be applied. This clipping threshold may be applied so that the respective gradients for the individual data items are scaled to be no larger than the clipping threshold. The clipping threshold may be determined in various ways (e.g., by using early training rounds to determine an average value of gradient norms) and specified as a hyperparameter for training (e.g., a federated user machine learning system). Additionally, the respective noise values may be applied to generate noisy gradients that protect privacy of the particular subject during aggregation. For example, as discussed above the noise value may be a Gaussian noise scale.

As shown in 450, a client of the federated clients may be selected to perform a decentralized aggregation of the respective training model. Then, as shown in 460, the select client may direct accumulation or aggregation of the noisy gradients from the respective other clients to generate a revised machine learning model where privacy of the particular subject is ensured.

FIG. 4 illustrates a computing system configured to implement the methods and techniques described herein, according to various embodiments. The computer system 1000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing subject level privacy attack analysis for federated learning, as described herein, may be provided as a computer program product, or software, that may include a non-transitory, computer-readable storage medium having stored thereon instructions, which may be used to program a computer system (or other electronic devices) to perform a process according to various embodiments. A non-transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1000 may include one or more processors 1070; each may include multiple cores, any of which may be single or multi-threaded. Each of the processors 1070 may include a hierarchy of caches, in various embodiments. The computer system 1000 may also include one or more persistent storage devices 1060 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.). Various embodiments may include fewer or additional components not illustrated in FIG. 4 (e.g., video cards, audio cards, additional network interfaces, peripheral devices, a network interface such as an ATM interface, an Ethernet interface, a Frame Relay interface, etc.)

The one or more processors 1070, the storage device(s) 1050, and the system memory 1010 may be coupled to the system interconnect 1040. One or more of the system memories 1010 may contain program instructions 1020. Program instructions 1020 may be executable to implement various features described above, including a machine learning model training system 1022 as discussed above with regard to FIGS. 1-5 that may perform the various training and application of re-ranking models, in some embodiments as described herein. Program instructions 1020 may be encoded in platform native binary, any interpreted language such as Java™ byte-code, or in any other language such as C/C++, Java™, etc. or in any combination thereof.

In one embodiment, Interconnect 1090 may be configured to coordinate I/O traffic between processors 1070, storage devices 1070, and any peripheral devices in the device, including network interfaces 1050 or other peripheral interfaces, such as input/output devices 1080. In some embodiments, Interconnect 1090 may perform any necessary protocol, timing or other data transformations to convert data signals from one component (e.g., system memory 1010) into a format suitable for use by another component (e.g., processor 1070). In some embodiments, Interconnect 1090 may include support for devices attached through various types of peripheral buses, such as a variant of the Peripheral Component Interconnect (PCI) bus standard or the Universal Serial Bus (USB) standard, for example. In some embodiments, the function of Interconnect 1090 may be split into two or more separate components, such as a north bridge and a south bridge, for example. In addition, in some embodiments some or all of the functionality of Interconnect 1090, such as an interface to system memory 1010, may be incorporated directly into processor 1070.

Network interface 1050 may be configured to allow data to be exchanged between computer system 1000 and other devices attached to a network, such as other computer systems, or between nodes of computer system 1000. In various embodiments, network interface 1050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1080 may, in some embodiments, include one or more display terminals, keyboards, keypads, touchpads, scanning devices, voice or optical recognition devices, or any other devices suitable for entering or retrieving data by one or more computer system 1000. Multiple input/output devices 1080 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1050.

Those skilled in the art will appreciate that computer system 1000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A method, comprising:
training, using a federation server and a plurality of clients, a machine learning model on a data set comprising a plurality of subjects individually comprising one or more data items, wherein the training comprises:
sampling, at individual ones of the plurality of clients, respective private data sets of the data set to generate respective private mini-batches;
aggregating respective counts of the plurality of subjects in respective private mini-batches to generate aggregate counts for the respective subjects;
computing respective noise values for the respective private mini-batches according to the respective counts of the plurality of subjects and the generated aggregate counts;
training respective machine learning models by individual ones of the plurality of clients according to the respective private mini-batches to generate respective noisy gradients for individual ones of the plurality of clients, the noisy gradients comprising the respective noise values for the respective private mini-batches; and
accumulating the respective noisy gradients to determine respective average gradients providing differential privacy for the respective subjects.

2. The method of claim 1, wherein to generate respective noisy gradients for individual ones of the plurality of clients, the method further comprises:
determining respective gradients for individual ones of a plurality of parameters of the respective machine learning models by the individual ones of the plurality of clients;
applying a clipping threshold to the determined respective gradients; and
adding the respective noise values for the respective private mini-batches to the determined respective gradients.

3. The method of claim 2, wherein the clipping threshold is a hyperparameter for the training of the machine learning model.

4. The method of claim 1, wherein individual ones of the private data sets of the data set comprise at least a portion of the plurality of subjects individually comprising one or more data items.

5. The method of claim 1, wherein the noise values are computed at a noise shuffler different from the federation server and the plurality of clients.

6. The method of claim 1, wherein one of the plurality of clients is an aggregating user, wherein the accumulating is performed by the aggregating user, and wherein the method further comprises:
applying the respective average gradients to a machine learning model of the aggregating user to generate an updated machine learning model; and
distributing the updated machine learning model by the aggregating user to individual ones of the plurality of clients other than the aggregating user.

7. The method of claim 1, wherein the sampling, aggregating, computing, training of the respective machine learning models by the plurality of clients and accumulating are performed for a mini-batch of the plurality of mini-batches of training of the machine learning model.

8. One or more non-transitory, computer-readable storage media, storing program instructions that when executed on or across a plurality of computing devices, cause the plurality of computing devices to implement a federated machine learning system performing:
training, using a federation server and a plurality of clients, a machine learning model on a data set comprising a plurality of subjects individually comprising one or more data items, wherein the training comprises performing:
sampling, at individual ones of the plurality of clients, respective private data sets of the data set to generate respective private mini-batches;
aggregating respective counts of the plurality of subjects in respective private mini-batches to generate aggregate counts for the respective subjects;
computing respective noise values for the respective private mini-batches according to the respective counts of the plurality of subjects and the generated aggregate counts;
training respective machine learning models by individual ones of the plurality of clients according to the respective private mini-batches to generate respective noisy gradients for individual ones of the plurality of clients, the noisy gradients comprising the respective noise values for the respective private mini-batches; and
aggregating the respective noisy gradients to determine respective average gradients providing differential privacy for the respective subjects.

9. The one or more non-transitory, computer-readable storage media of claim 8, wherein to generate respective noisy gradients for individual ones of the plurality of clients, the federated machine learning system further performs:
determining respective gradients for individual ones of a plurality of parameters of the respective machine learning models by the individual ones of the plurality of clients;
applying a clipping threshold to the determined respective gradients; and
adding the respective noise values for the respective private mini-batches to the determined respective gradients.

10. The one or more non-transitory, computer-readable storage media of claim 9, wherein the clipping threshold is a hyperparameter for the training of the machine learning model.

11. The one or more non-transitory, computer-readable storage media of claim 8, wherein individual ones of the private data sets of the data set comprise at least a portion of the plurality of subjects individually comprising one or more data items.

12. The one or more non-transitory, computer-readable storage media of claim 8, wherein the noise values are computed at a noise shuffler different from the federation server and the plurality of clients.

13. The one or more non-transitory, computer-readable storage media of claim 8, wherein one of the plurality of clients is an aggregating user, wherein the accumulating is performed by the aggregating user, and wherein the federated machine learning system further performs:
applying the respective average gradients to a machine learning model of the aggregating user to generate an updated machine learning model; and
distributing the updated machine learning model by the aggregating user to individual ones of the plurality of clients other than the aggregating user.

14. The one or more non-transitory, computer-readable storage media of claim 8, wherein the sampling, aggregating, computing, training of the respective machine learning models by the plurality of clients and accumulating are performed for a mini-batch of the plurality of mini-batches of training of the machine learning model.

15. A system, comprising:
a plurality of clients of a federated machine learning system individually comprising at least one processor and a memory; and
a federation server comprising at least one processor and a memory configured to coordinate training of a machine learning model using the plurality of clients and a data set comprising a plurality of subjects individually comprising one or more data items; and
a noise shuffler comprising at least one processor and a memory configured to:
aggregate respective counts of the plurality of subjects received from individual ones of the plurality of clients to generate aggregate counts for the respective subjects;
compute respective noise values for the respective ones of the plurality of clients according to the respective counts of the plurality of subjects received from individual ones of the plurality of clients and the generated aggregate counts; and send the respective noise values to the respective ones of the plurality of clients;
wherein individual ones of the plurality of clients are configured to:
sample a private data set of the data set to generate a private mini-batch;
generate respective counts of the plurality of subjects in the private mini-batch to generate aggregate counts for the respective subjects;
send the generated respective counts to the noise shuffler;
receive the respective noise values from the noise shuffler;
acquire a local machine learning model from an aggregating user;
train a local machine learning model according to the private mini-batch to generate respective noisy gradients comprising the respective noise values; and
send for accumulation the respective noisy gradients to the aggregating user.

16. The system of claim 15, wherein to generate respective noisy gradients individual ones of the plurality of clients are configured to:
determine respective gradients for individual ones of a plurality of parameters of the respective machine learning models;
apply a clipping threshold to the determined respective gradients; and
add the respective noise values for the respective private mini-batches to the determined respective gradients.

17. The system of claim 16, wherein the clipping threshold is a hyperparameter for the training of the machine learning model.

18. The system of claim 15, wherein individual ones of the private data sets of the data set comprise at least a portion of the plurality of subjects individually comprising one or more data items.

19. The system of claim 15, wherein one of the plurality of clients is the aggregating user, and wherein the aggregating user is configured to:
accumulate the respective noisy gradients from individual ones of the plurality of clients to determine respective average gradients providing differential privacy for the respective subjects;
apply the respective average gradients to a local machine learning model of the aggregating user to generate an updated machine learning model; and
distribute the updated machine learning model to individual ones of the plurality of clients other than the aggregating user.

20. The system of claim 15, wherein the sampling, generating, sending, receiving, acquiring, training and sending for accumulation are performed by the individual ones of the plurality of clients for an iteration of a plurality of iterations of training of the machine learning model.
